(19) United States
(12) Patent Application Publication
(10) Pub. No.: US 2010/0086323 A1
(43) Pub. Date: Apr. 8, 2010

(54) IMAGE FORMING APPARATUS

(75) Inventors: Hiroyuki SAITO, Tokyo (JP); Seiko ITAGAKI, Tokyo (JP); Hiroshi AKITA, Tokyo (JP); Natsuko MINEGISHI, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA BUSINESS TECHNOLOGIES, INC., Tokyo (JP)

(21) Appl. No.: 12/574,725

(22) Filed: Oct. 7, 2009

(30) Foreign Application Priority Data
Oct. 8, 2008 (JP) 2008261508

(51) Int. Cl. G03G 15/06

(52) U.S. Cl. 399/55

(57) ABSTRACT

An image forming apparatus includes: a supplying section for supplying developer; a first developing roller including plural magnetic poles and a first sleeve arranged rotatable to the first developing roller; a second developing roller including plural magnetic poles and a second sleeve arranged rotatable to the second developing roller, the second developing roller arranged adjacent to the first developing roller and parallel to the same; an electrode arranged between the first and second developing rollers; and a voltage applying unit for applying bias voltages each having different electric potential corresponding to the first developing roller, the second developing roller and the electrode, wherein an absolute value of the bias voltage to be applied to the electrode is larger than that of the bias voltage to be applied to the first developing roller and smaller than that of the bias voltage to be applied to the second developing roller.

### BACKGROUND OF THE INVENTION

1. Field of the Invention

The present invention relates to an image forming apparatus.

2. Description of Related Art

Recently, an image forming apparatus having two developing rollers in a developing area so as to keep good developing performance is proposed along with faster image forming processing. Here, the developing performance means performance to develop right amount of toner and to avoid bad image forming occurred by fog of background density, beads carry over or the like.

If the two developing rollers are arranged in the developing area, a developer flows through a flow path, which goes in a single direction through a supplying section for supplying the developer, a regulating section for regulating flow rate of the developer, first and second developing rollers each for developing tonner image to a latent image carrier, and a retrieve section for retrieving developer remained on the second developing roller after a development.

Here, the regulating section is generally located not adjacent to the second developing roller to which the developer is supplied from the first developing roller but adjacent to the first developing roller. That is because, if two regulating sections are respectively arranged adjacent to the first and second developing rollers, such problems may occur that a developing apparatus significantly grows in size or deterioration of the developer may be accelerated.

For the first developing roller, locating the regulating section has a merit that the tonner adhered on a surface of the first developing roller is removed. To put it concretely, the remaining toner on a sleeve, which is rotatably arranged on a surface of the first developing roller, is removed by a developer chamber, which is formed by the regulating section and scrapes against the sleeve.

On the other hand, tonner pollution occurs on a sleeve of the second developing roller for the reason that a developer chamber is not formed because the regulating section is not located adjacent to the second developing roller. Progression of the tonner pollution causes bad image forming such as color cast in a foundation or decrease in concentration, which finally leads to reduction of the developing performance.

For the image forming apparatus having two developing rollers, how to resolve the tonner pollution on the sleeve of the second developing roller is a problem to keep good developing performance.

Japanese Patent Application Laid-Open publication No. 2006-139227 discloses a technique for electrically displacing the tonner adhered on the sleeve of the second developing roller to the latent image carrier or to the first developing roller in a tonner removing mode.

Moreover, Japanese Patent Application Laid-Open publication No. 10-312110 discloses a technique for electrically flying the tonner adhered on the sleeve of a developing roller to a conductive roller and removing the tonner on the conductive roller by a blade.

However, the technique disclosed in Japanese Patent Application Laid-Open Publication No. 2006-139227 cannot remove the tanner adhered on the sleeve of the second developing roller without being shifted to a particular mode such as the tonner removing mode.

Moreover, in the technique disclosed in Japanese Patent Application Laid-Open Publication No. 10-312110, removal effect gradually deteriorates because making the blade to be contacted with the conductive roller leads the tonner adhered on the conductive roller.

### SUMMARY OF THE INVENTION

It is, therefore, a main object of the present invention to provide an image forming apparatus, which can stably remove the tonner adhered on the sleeve of the second developing roller effectively when developing.

According to a first aspect of the present invention, there is provided an image forming apparatus, including: a supplying section for supplying developer; a first developing roller including a plurality of magnetic poles and a first sleeve arranged rotatable to the first developing roller; a second developing roller including a plurality of magnetic poles and a second sleeve arranged rotatable to the second developing roller, the second developing roller arranged adjacent to the first developing roller and parallel to the same; an electrode arranged between the first and second developing rollers; and a voltage applying unit for applying bias voltages each having different electric potential corresponding to the first developing roller, the second developing roller and the electrode, wherein an absolute value of the bias voltage to be applied to the electrode is larger than an absolute value of the bias voltage to be applied to the first developing roller and smaller than an absolute value of the bias voltage to be applied to the second developing roller.

Preferably, the electrode is arranged along axes of the first and second developing rollers.

Preferably, the electrode is in the form of wire, mesh or plate.

Preferably, the electrode is composed of a plurality of small electrodes, and the voltage applying unit applies bias voltages each having phase that differs corresponding to each of the plurality of small electrodes.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a block diagram showing a skeleton framework of an image forming apparatus according to a first embodiment of the present invention;

FIG. 2 is a block diagram showing a skeleton framework of a developing device according to the first embodiment of the present invention;

FIG. 3 is a perspective view showing positional relationship among an electrode, a first developing roller and a second developing roller;

FIG. 4 is a diagram showing a flow path for a developer when in developing;

FIG. 5 is a diagram showing movement of the tonner positioned adjacent to the electrode;

FIG. 6 is a diagram showing relationship between a coulomb force [C] exerted on the tonner and a distance D from the second developing roller [mm];

FIG. 7 is a block diagram showing a skeleton framework of a developing device according to a second embodiment of the present invention;

FIG. 8 is a table showing a result of a performance assessment test to the image forming apparatus 100 according to the first embodiment of the present invention; and

FIG. 9 is a table showing a result of a performance assessment test to the image forming apparatus 100 according to the second embodiment of the present invention.

### DESCRIPTION OF THE PREFERRED EMBODIMENTS

In the following, the best modes for implementing the present invention are described with reference to the attached drawings. While various technically preferable features are described below, the scope of the invention is not limited to the following embodiments and illustrated examples.

### First Embodiment

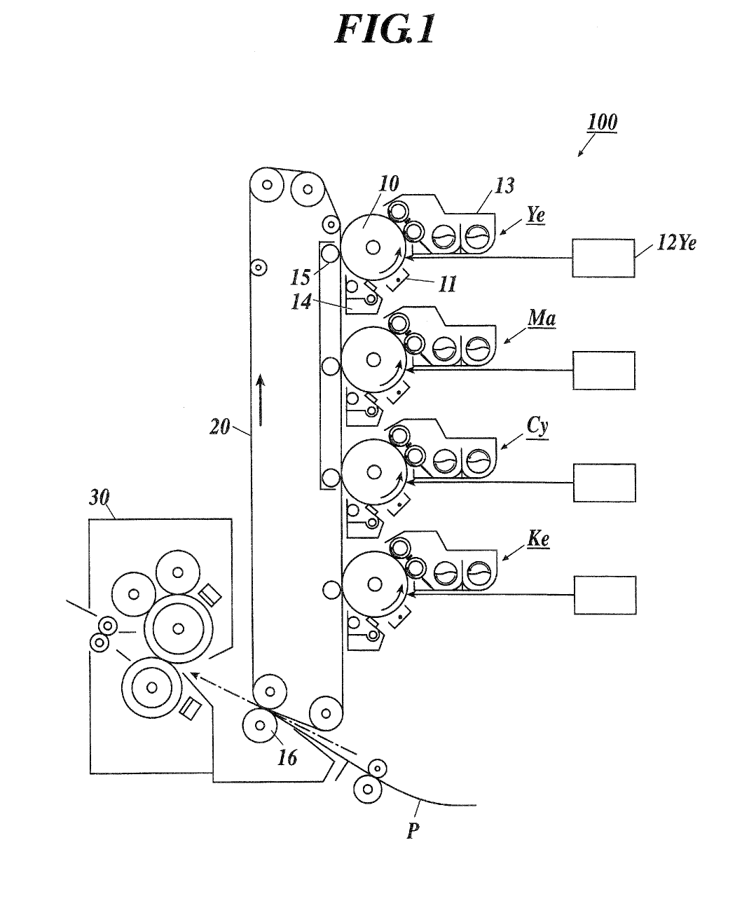

FIG. 1 is a block diagram showing a skeleton framework of an image forming apparatus 100 according to a first embodiment of the present invention.

The image forming apparatus 100 includes a yellow image forming section Ye, a magenta image forming section Ma, a cyan image forming section Cy and a black image forming section Ke. Each of the image forming sections Ye, Ma, Cy and Ke is arranged along a moving direction of an intermediate transcriptional body 20.

Each of the image forming sections Ye, Ma, Cy and Ke has the same configuration and function. Therefore, hereinafter, a configuration and a function of the yellow image forming section Ye will be described as an example.

The yellow image forming section Ye includes a photoreceptor 10, a charging device 11, an exposure device 12, a developing device 13, a cleaning device 14, a primary transcription roller 15 and the like. Each of the devices is arranged around the photoreceptor 10 along a rotational direction of the photoreceptor 10.

The charging device 11 uniformly charges a surface of the photoreceptor 10. The exposure device 12 exposes the charged photoreceptor 10 to form a latent image.

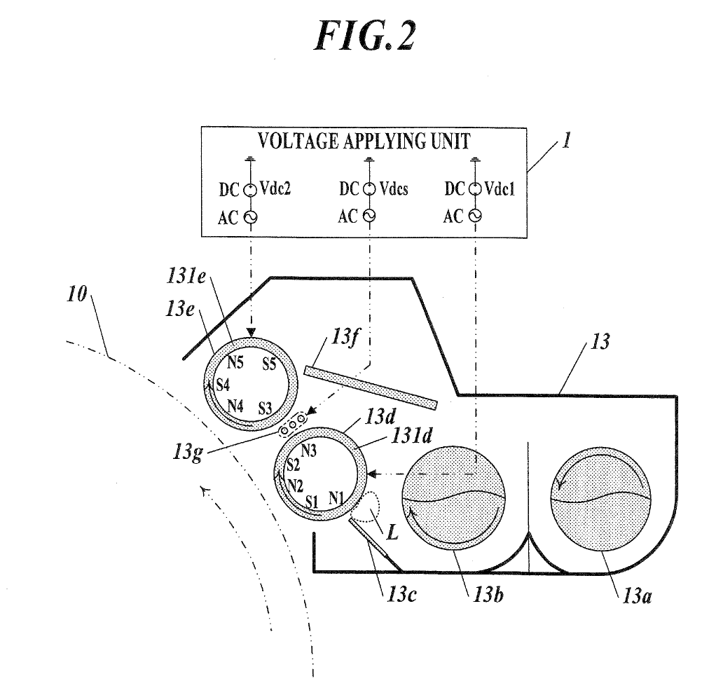

The developing device 13 develops the latent image formed by the exposure device 12 on the photoreceptor 10. Here, a detailed configuration and a motion of the developing device 13 will be described on and after FIG. 2 in the following.

The cleaning device 14 retrieves/removes a yellow tonner, which is not transferred to the intermediate transcriptional body 20 and remains on the surface of the photoreceptor 10.

The primary transcription roller 15 transfers a yellow tonner image formed on the photoreceptor 10 to the intermediate transcriptional body 20.

The intermediate transcriptional body 20 is formed in the shape of a belt and transports a monochrome/full color tonner image formed on the intermediate transcriptional body 20 to a secondary transcription roller 16.

The secondary transcription roller 16 transfers the tonner image transferred on the intermediate transcriptional body 20 to a sheet P. A fixing device 30 fixes the tanner image formed on the sheet P after transferring.

FIG. 2 shows a block diagram showing a skeleton framework of the developing device 13.

The developing device 13 includes an agitating section 13a, a supplying section 13b, a regulating section 13c, a first developing roller 13d, a second developing roller 13e, a retrieve section 13f, an electrode 13g and the like.

The agitating section 13a includes a screw and agitates nonmagnetic tonner and magnetic carrier to be frictionally charged at a constant rate to generate a developer.

The supplying section 13b includes a screw and receives the developer from the agitating section 13a to supply the developer to the first developing roller 13d by the screw.

The regulating section 13c regulates a flow rate of the developer to be supplied from the supplying section 13b to the first developing roller 13d. Here, the regulating section 13c forms a developer chamber L by regulating the flow rate of the developer. The developer chamber L scrapes against a first sleeve 131d of the first developing roller 13d to remove the tonner adhered on the first sleeve 131d.

The first developing roller 13d interiorly includes a plurality of magnetic poles and includes the first sleeve 131d arranged rotatable to a surface of the first developing roller 13d.

“N” and “S” shown in the figures represent polar characters, and different numbers in a same pole (for example, N1 and N2) represent that magnetic flux density [mT] is different. Here, a portion without magnetic pole may be a space or may be installed with a nonmagnetic member.

The first developing roller 13d carries the developer by the plurality of magnetic poles and by rotation of the first sleeve 131d to develop the latent image formed on the photoreceptor 10.

Moreover, the first developing roller 13d supplies the developer to the second developing roller 13e.

The second developing roller 13e has the same configuration as the first developing roller 13d except for locations of magnetic poles and magnetic flux density [mT] of each of the magnetic poles.

The second developing roller 13e receives the developer from the first developing roller 13d and develops the latent image formed on the photoreceptor 10 by using the received developer.

A tonner image is formed on the photoreceptor 10 by the developing processing performed by the first developing roller 13d and the second developing roller 13e.

The retrieve section 13f retrieves the developer from the second developing roller 13e.

The electrode 13g is composed of such as tungsten or stainless steel (SUS) and arranged between the first developing roller 13d and the second developing roller 13e. Moreover, the electrode 13g extends along axes of the first developing roller 13d and the second developing roller 13e.

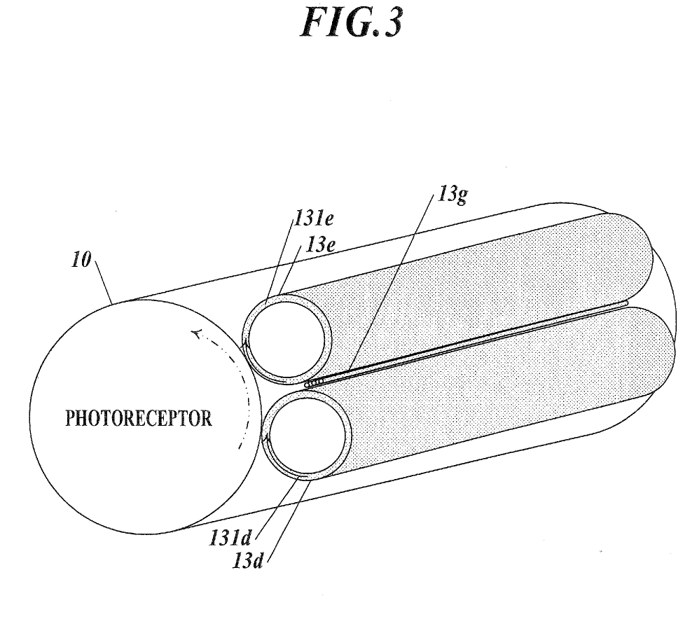

FIG. 3 shows a perspective view showing positional relationship among the electrode 13g, the first developing roller 13d and the second developing roller 13e.

As shown in FIG. 3, the electrode 13g is composed of three small electrodes, which are in the form of wire and extend along axes of the first developing roller 13d and the second developing roller 13e. Incidentally, the number of the small electrodes in the form of wire is not limited to three. Moreover, the shape of the electrode 13g is not limited to be in the form of wire but may be in the form of mesh or plate.

A voltage applying unit 1 applies bias voltages each having different electric potential corresponding to the first developing roller 13d, the second developing roller 13e and the electrode 13g.

Absolute value of each bias voltage to be applied satisfies a relationship of |Vdc1|<|Vdcs|<|Vdc2|, in which Vdc1 represents bias voltage to be applied to the first developing roller 13d, Vdc2 represents bias voltage to be applied to the second developing roller 13e and Vdcs represents bias voltage to be applied to the electrode 13g.

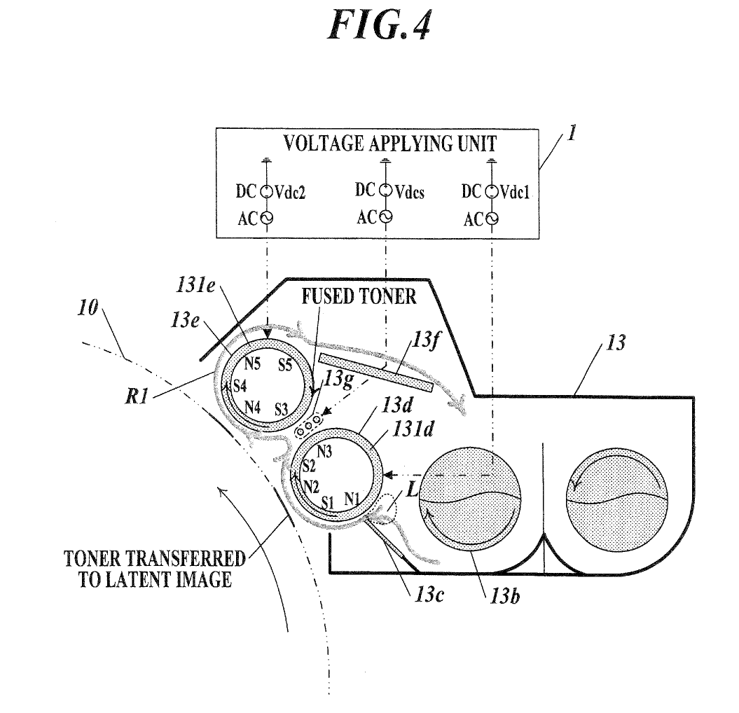

Next, a flow path for the developer at a time of development will be explained with reference to FIG. 4.

The developer flows from the supplying section 13b via the regulating section 13c to the first developing roller 13d.

At the first developing roller 13d, a part of the tonner included in the developer is transferred to the latent image formed on the photoreceptor 10. Moreover, the developer flows from the first developing roller 13d to the second developing roller 13e.

At the second developing roller 13e, a part of the tonner included in the developer is transferred to the latent image formed on the photoreceptor 10. Then, remaining developer, which does not contribute to the development, is retrieved by the retrieve section 13f. Here, a part of the tanner included in the developer is not retrieved by the retrieve section 13f to be adhered to the second sleeve 131e. The adhered tanner moves along with rotation of the second sleeve 131e and flows adjacent to the electrode 13g.

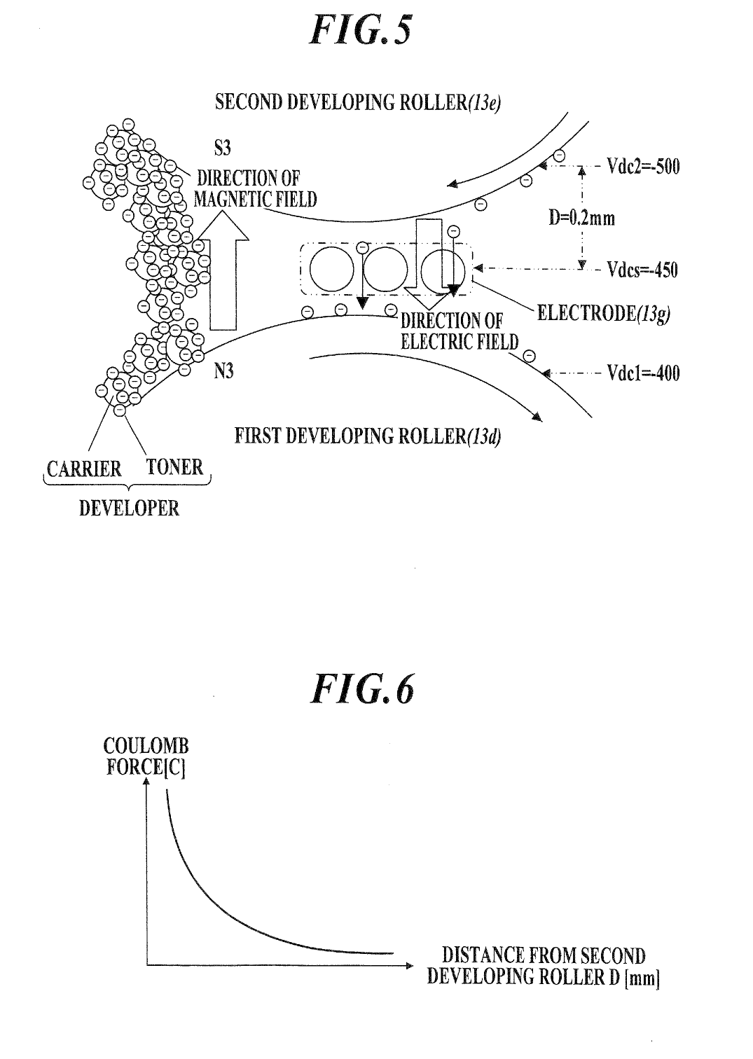

FIG. 5 shows a movement of the tanner positioned adjacent to the electrode 13g.

As shown in FIG. 5, bias voltages each having different electric potential are applied corresponding to the first developing roller 13d, the second developing roller 13e and the electrode 13g by the voltage applying unit 1. In this embodiment, the first developing roller 13d is applied with a bias voltage of Vdc1=−400 [V], the second developing roller 13e is applied with a bias voltage of Vdc2=−500 [V] and the electrode 13g is applied with a bias voltage of Vdcs=−450 [V].

In the neighborhood of the electrode 13g, an electric field is produced in a direction from the second developing roller 13e to the first developing roller 13d since electric potentials of the corresponding bias voltages to be applied are different from one another.

The tanner adhered to the second sleeve 131e transfers from the second developing roller 13e to the electrode 13g by the electric field, and further transfers from the electrode 13g to the first sleeve 131d.

As shown in FIG. 6, the electrode 13g needs to be installed at a position where distances from the first developing roller 13d and the second developing roller 13e are not too far because Coulomb force [C] exerted on the tonner is inversely proportional to the distances D. In this embodiment, the distance D is 0.2 [mm].

The tonner transferred from the second sleeve 131e via the electrode 13g to the first sleeve 131d moves along with a rotation of the first sleeve 131d to be exfoliated and to be removed from the first sleeve 131d by the developer chamber L. Alternatively, the tonner transferred to the first sleeve 131d is removed by being flied from the first sleeve 131d by the magnetic field produced between the magnetic poles N1, N3 of the first developing roller 13d.

According to the above described configuration, it is possible to transfer the tonner adhered to the second sleeve 131e of the second developing roller 13e to the first developing roller 13d during a normal image forming processing without shifting particular mode for removing the tonner. That is, the tonner adhered to the second developing roller 13e can be removed stably when in developing.

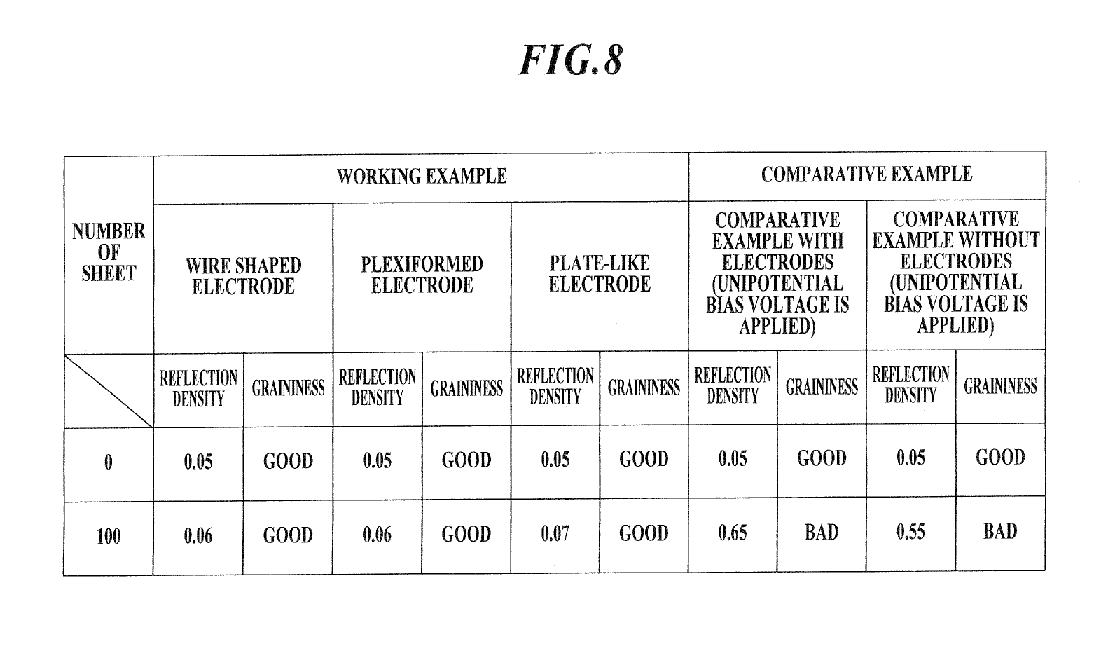

A result of a performance assessment test to the image forming apparatus 100 will be shown in FIG. 8.

### WORKING EXAMPLE

The performance assessment test for the image forming apparatus 100 has carried out on the cases in which the electrode 13g is configured in the form of wire, mesh or plate.

In the performance assessment test, a predetermined image is formed on each of 100,000 sheets, and then, reflection density and graininess are checked as to before and after an image formation. Regarding the graininess, visual judgment as to whether the printed image is rough or not is adopted as a criterion.

The working example gave results that, in any case where the electrode 13g is formed in the shape of wire, mesh or plate, the reflection density does not change much before and after the image formation and the graininess is good.

### COMPARATIVE EXAMPLE

A performance assessment test for an image forming apparatus has carried out as to a case where unipotential bias voltage is applied to the first developing roller 13d, the second developing roller 13e and the electrode 13g (hereinafter, called as comparative example with electrodes).

Moreover, a performance assessment test for an image forming apparatus has carried out as to a case where the electrode is removed (hereinafter, called as comparative example without electrodes).

The comparative example with electrodes gave results that the reflection density changes much from 0.05 to 0.65 around the image formation and the graininess becomes bad.

Moreover, the comparative example without electrodes gave results that the reflection density changes much and the graininess becomes bad as in the comparative example with electrodes.

As described above, according to the first embodiment, by arranging the electrode 13g between the first developing roller 13d and the second developing roller 13e and applying bias voltages each having different electric potential, the tonner adhered to the second sleeve 131e can be transferred to the first sleeve 131d when in development. The tonner adhered to the second sleeve 131e can be removed stably and effectively, and bad image forming caused by a tonner pollution can be resolved.

Moreover, it is not necessary to shift to a particular mode such as a mode for removing the tonner, and physical contact between a sleeve and a blade or the like does not occur.

Moreover, the electrode 13g may be shaped in any form of wire, mesh or plate, and same advantage to resolve tonner pollution can be obtained in any case of shape of the electrode 13g.

### Second Embodiment

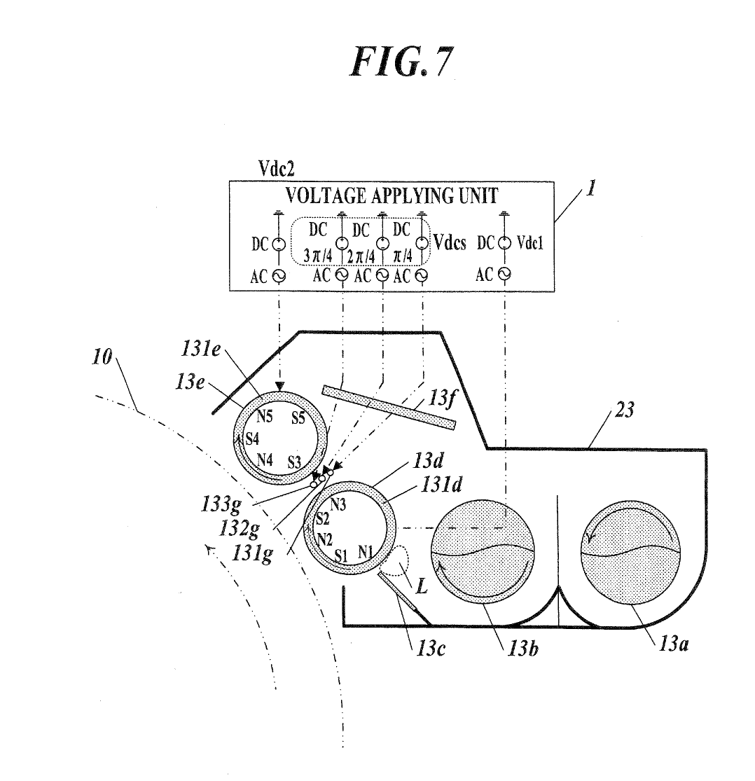

FIG. 7 shows a developing apparatus 23 according to a second embodiment of the present invention.

Here, the same sign will be assigned to parts, in which configuration and motion are the same as in the first embodiment and the explanation will be omitted.

The developing apparatus 23 includes small electrodes 131g, 132g and 133g. The small electrodes 131g-133g are connected to different power sources, respectively.

The voltage applying unit 1 applies bias voltages each having different phase corresponding to the small electrodes 131g-133g. Concretely, the voltage applying unit 1 applies bias voltage to each of the small electrodes 131g-133g, wherein each phase of the bias voltage is shifted by π/4. Here, each of the bias voltages to be applied corresponding to the small electrodes 131g-133g has the same electric potential.

Absolute value of each bias voltage to be applied corresponding to the first developing roller 13d, the second developing roller 13e and the small electrodes 131g-133g satisfies, as in the first embodiment, a relationship of |Vdc1|<|Vdcs|<|Vdc2|, in which Vdcs represents bias voltage to be applied to the small electrodes 131g-133g.

The voltage applying unit 1 applies bias voltage that satisfies above relationship and is shifted by a predetermined phase. By doing so, an electric field directed from the small electrode 131g to the small electrode 133g (hereinafter, called as a traveling wave electric field) is produced as well as an electric field directed from the second developing roller 13e to the first developing roller 13d.

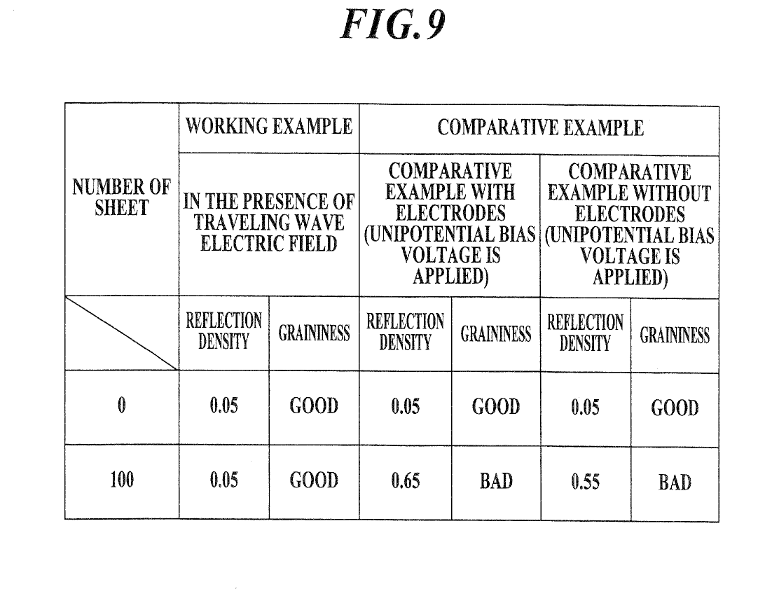

FIG. 9 shows a result of a performance assessment test to the image forming apparatus 100.

### WORKING EXAMPLE

The performance assessment test for the image forming apparatus 100 has carried out, in which the image forming apparatus 100 includes the developing apparatus 23 for producing the traveling wave electric field at the small electrodes 131g-133g.

In the performance assessment test, a predetermined image is formed on each of 100,000 sheets, and then, reflection density and graininess are checked as to before and after an image formation. Regarding the graininess, visual judgment as to whether the printed image is rough or not is adopted as a criterion.

The working example gave results that the reflection density does not change much before and after the image formation and the graininess is good.

### COMPARATIVE EXAMPLE

The comparative example with electrodes and the comparative example without electrodes each shown in FIG. 9 is the same as shown in FIG. 8, so the explanation will be omitted.

As described above, according to the second embodiment of the present invention, the traveling wave electric field can be produced by applying bias voltages each having different electric potential corresponding to the small electrodes 131g-133g.

By producing the traveling wave electric field, the tonner adhered to the second sleeve 131e can be more strongly vibrated, and therefore, advantageous effect to remove the tonner can be improved. Moreover, effectives for removing the tonner to be adhered to the small electrodes 131g-133g can be proposed.

As above described, according to the embodiments of the present invention, the image forming apparatus 100 includes: a supplying section 13b for supplying developer; a first developing roller 13d including a plurality of magnetic poles and a first sleeve 131d arranged rotatable to the first developing roller 13d; a second developing roller 13e including a plurality of magnetic poles and a second sleeve 131e arranged rotatable to the second developing roller 13e, the second developing roller 13e arranged adjacent to the first developing roller 13d and parallel to the same; an electrode 13g arranged between the first and second developing rollers 13d, 13e; and a voltage applying unit 1 for applying bias voltages each having different electric potential corresponding to the first developing roller 13d, the second developing roller 13e and the electrode 13g, wherein an absolute value of the bias voltage to be applied to the electrode 13g is larger than an absolute value of the bias voltage to be applied to the first developing roller 13d and smaller than an absolute value of the bias voltage to be applied to the second developing roller 13e.

Preferably, the electrode 13g is arranged along axes of the first and second developing rollers 13d, 13e.

Preferably, the electrode 13g is in the form of wire, mesh or plate.

Preferably, the electrode 13g is composed of a plurality of small electrodes 131g, 132g, 133g, and the voltage applying unit 1 applies bias voltages each having phase which differs corresponding to each of the plurality of small electrodes 131g, 132g, 133g.

The entire disclosure of Japanese Patent Application No. 2008-261508 filed on Oct. 8, 2008 including description, claims, drawings, and abstract are incorporated herein by reference in its entirety.

Although various exemplary embodiments have been shown and described, the invention is not limited to the embodiments shown. Therefore, the scope of the invention is intended to be limited solely by the scope of the claims that follow.

What is claimed is:

1. An image forming apparatus, comprising:
a supplying section for supplying developer;
a first developing roller including a plurality of magnetic poles and a first sleeve arranged rotatable to the first developing roller;
a second developing roller including a plurality of magnetic poles and a second sleeve arranged rotatable to the second developing roller, the second developing roller arranged adjacent to the first developing roller and parallel to the same;
an electrode arranged between the first and second developing rollers; and
a voltage applying unit for applying bias voltages each having different electric potential corresponding to the first developing roller, the second developing roller and the electrode,
wherein an absolute value of the bias voltage to be applied to the electrode is larger than an absolute value of the bias voltage to be applied to the first developing roller and smaller than an absolute value of the bias voltage to be applied to the second developing roller.

2. The image forming apparatus of claim 1, wherein
the electrode is arranged along axes of the first and second developing rollers.

3. The image forming apparatus of claim 1, wherein
the electrode is in the form of wire, mesh or plate.

4. The image forming apparatus of claim 1, wherein
the electrode is composed of a plurality of small electrodes, and
the voltage applying unit applies bias voltages each having phase which differs corresponding to each of the plurality of small electrodes.
